(19) United States
(12) Patent Application Publication
(10) Pub. No.: US 2021/0101644 A1
(43) Pub. Date: Apr. 8, 2021

(54) MULTIPLE PIECE DRIVETRAIN COMPONENT BRACKET

(71) Applicants: Neelan A. Nadesan, Waterford, MI (US); Krishant Patel, Oxford, MI (US); Brian D. Dwyer, Ortonville, MI (US); Todd M. Wirges, Troy, MI (US)

(72) Inventors: Neelan A. Nadesan, Waterford, MI (US); Krishant Patel, Oxford, MI (US); Brian D. Dwyer, Ortonville, MI (US); Todd M. Wirges, Troy, MI (US)

(21) Appl. No.: 17/060,192

(22) Filed: Oct. 1, 2020

Related U.S. Application Data
(60) Provisional application No. 62/909,277, filed on Oct. 2, 2019.

(51) Int. Cl. B62D 27/02

(52) U.S. Cl. CPC B62D 27/02

(57) ABSTRACT

In at least some implementations, a bracket for mounting a drivetrain component to a vehicle, includes a first extruded section having a first connection element, and a second extruded section having a second connection element, where the first connection element is mated with the second connection element. The first extruded section and the second extruded section are press-fitted together with a load-bearing interference fit between the first connection element and the second connection element.

### REFERENCE TO RELATED APPLICATIONS

This application claims the benefit of U.S. Provisional Application Ser. No. 62/909,277 filed on Oct. 2, 2019, the entire contents of which is incorporated herein by reference in its entirety.

### FIELD

The present disclosure relates to a bracket for mounting a drivetrain component, such as a rear differential module, to a vehicle structural component.

### BACKGROUND

Brackets or other mounting structures may be used to support and mount a drivetrain component, like a front or rear differential module, to the vehicle structural frame or a structural component of the vehicle. Prior brackets have been die cast as a single piece bracket that is heavy and expensive to produce.

### SUMMARY

In at least some implementations, a bracket for mounting a drivetrain component to a vehicle, includes a first extruded section having a first connection element, and a second extruded section having a second connection element, where the first connection element is mated with the second connection element. The first extruded section and the second extruded section are press-fitted together with a load-bearing interference fit between the first connection element and the second connection element.

In at least some implementations, the first connection element includes a projection that protrudes outwardly from the first extruded section and the second connection element includes a void arranged to receive the projection with an interference fit provided between the projection and the void. The first extruded section may include a first end and a second end, the first connection element may be located at the second end of the first extruded section and have a larger portion and a smaller portion, and the smaller portion may be closer to the first end than the larger portion. The second connection element may be complementarily shaped to the first connection element. The first end may be spaced from the second end along a longitudinal axis and the larger portion may be larger than the smaller portion in a dimension perpendicular to the longitudinal axis. In at least some implementations, the first connection element has a distal end farthest from the first end, and the second extruded section has a first end and a second end, the second connection element being located at the second end, and the distal end of the first connection element is closer to the first end of the second extruded section than is a portion of the second extruded section.

In at least some implementations, the first connection element and the second connection element are overlapped in a direction perpendicular to direction in which the first extruded section and second extruded section are press-fitted together.

In at least some implementations, the first connection element and the second connection element are overlapped in two directions that are perpendicular to each other and are also perpendicular to the direction in which the first extruded section and second extruded section are press-fitted together.

In at least some implementations, the first connection element includes a concave portion and a convex portion and the second connection element includes a concave portion and a convex portion. The concave portion and convex portion of both the first connection element and the second connection element may be oriented perpendicular to a direction in which the first extruded section and second extruded section are press-fitted together. The convex portion of the first connection element may be larger than, or has a different curvature or shape than, the concave portion of the second connection element.

In at least some implementations, an extruded bracket for mounting a drivetrain component to a vehicle structural component, includes a first extruded section having a first connection element and a first recess, and a second extruded section coupled to the first extruded section in a first direction, the second extruded section having a second connection element and a second recess, where the first connection element is coupled with and overlaps the second connection element parallel to a longitudinal axis of the first extruded section and second extruded section. The first recess and the second recess define a circular opening that is configured to be installed around a shaft, and the circular opening having an axis that is perpendicular to the longitudinal axis. The first extruded section and the second extruded section are press-fitted together with a load-bearing interference fit between the first connection element and the second connection element.

In at least some implementations, the first connection element and second connection element are overlapped in a direction perpendicular to both the longitudinal axis and the axis of the circular opening.

### BRIEF DESCRIPTION OF THE DRAWINGS

FIG. 1 is a side view of an extruded bracket having two sections mated together via connection elements that include a projection and void configuration;

FIG. 2 is an enlarged fragmentary view showing a first connection element coupled with a second connection element in the projection and void configuration shown in FIG. 1;

FIG. 3 is a side view of an extruded bracket where the connection elements include an undulated configuration; and

FIG. 4 is an enlarged fragmentary view showing the first connection element coupled with a second connection element in the undulated configuration shown in FIG. 3.

### DETAILED DESCRIPTION

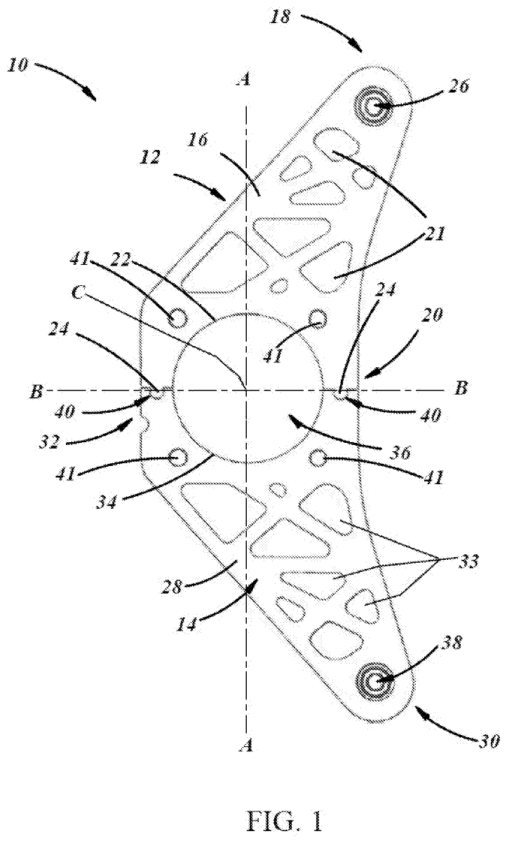

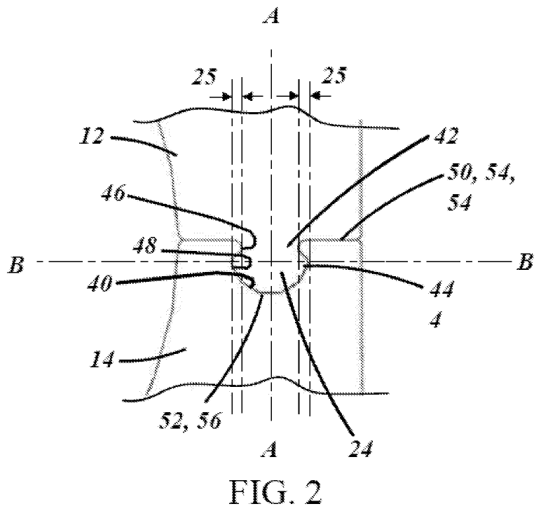

Referring in more detail to the drawings, FIGS. 1 and 2 illustrate an extruded bracket 10 including a first extruded section 12 that is coupled to a second extruded section 14. The bracket 10 can be used to mount a drivetrain component, such as a front or rear differential module, to a vehicle cradle. The first extruded section 12 and the second extruded section 14 can be press-fitted or otherwise force-fit together to form a load-bearing interference fit and may be overlapped in one or more dimensions to inhibit separation of these sections in load-bearing directions (e.g. directions supporting the weight or forces of the differential module). For ease of description, the fit between the sections will hereafter be referred to as a press-fit, which is intended to include different ways of fitting the sections together, including by impact or application of other force to one or both sections.

Press-fitting the first extruded section 12 and the second extruded section 14 to form the bracket 10 provides a lighter bracket for supporting a differential module and mounting it to a vehicle cradle. Conventional extrusion manufacturing processes do not allow production of single piece brackets in a size needed for supporting and mounting the rear differential module to the vehicle cradle, and alternative die cast one-piece bracket designs are heavier and more expensive. By utilizing a press-fitting process, the extruded bracket 10 provides a larger extruded bracket 10 without needing to weld multiple parts or having a bracket defined by separate pieces.

The first extruded section 12 can include a first body 16 that extends generally along or in the direction of a longitudinal axis A from a first end 18 to a second end 20. The first body 16 can be formed of metal, for example steel or aluminum. In at least some implementations, the first end 18 can be narrower than the second end 20. In at least some implementations, the first body 16 can include at least one opening or void 21 where material has been removed (e.g. for reducing weight).

Additionally, the first extruded section 12 can include a first recess 22 disposed proximate to and defining part of the second end 20. In at least some implementations, the first recess 22 may define a semi-circle or a partial circle having a radius sized to receive a shaft or post. In at least some implementations, the first recess 22 may be disposed between multiple first connection elements 24 that extend from and define part of the second end 20. The connection elements may extend longitudinally away from the first end. The connection elements 24 may be located farther from the first end 18 than at least part of and up to all of the first recess 22.

The first extruded section 12 can include at least one first cradle mount opening 26 which may be located proximate to the first end 18. The first cradle mount opening 26 may receive a bolt or other connector therethrough to couple the bracket to a vehicle cradle (not shown). The vehicle cradle may include a corresponding opening that may receive the bolt or other connector.

The first extruded section 12 can include at least one first connection element 24 for coupling to the second extruded section 14 and may be complementary in shape to a respective second connection element 40 of the second extruded section 14, preferably with an interference fit between them. Each first connection element 24 can protrude from the second end 20 of the body and may include a convex, concave, and/or irregular shape. In some implementations and as illustrated in FIGS. 1 and 2, the first extruded section 12 includes multiple first connection elements 24 that may be symmetrically arranged relative to the longitudinal axis A and each including a generally convex tab protruding in the direction of the longitudinal axis A away from the adjacent portions of the second end 20. It will be appreciated that each first connection element 24 may include other shapes, positions, and configurations.

The second extruded section 14 of the bracket 10 may be arranged to be press-fitted to the first extruded section 12 to define a unitary bracket 10, as noted above. In at least some implementations, the second extruded section 14 can at least substantially be a mirror image of the first extruded section 12, and include one or more second connection elements 40 that are arranged to mate with and in at least some implementations, be complementary in shape to the first connection element(s) 24.

The second extruded section 14 can include an extruded part having a second body 28 that extends from a first end 30 to a second end 32 generally along longitudinal axis A (e.g. the body extends longitudinally between the first end 30 and second end 32). The second body 28 can also be formed of metal, for example steel or aluminum. In at least some implementations, the first end 30 can be narrower than the second end 32. In at least some implementations, the second body 28 can include at least one opening or void 33 where material has been removed (e.g., for reducing weight).

Additionally, the second extruded section 14 can include a second recess 34 disposed proximate to the second end 32. In at least some implementations, the second recess 34 may define a semi-circle or a partial circle. In at least some implementations, the second recess 34 may be disposed between multiple second connection elements 40 and can be configured to face/confront the first recess 22 and may have the same size and shape as the first recess 22 to define a circle with the first recess 22 when the first section 12 and second section 14 are coupled together.

Similar to the first extruded section 12, the second extruded section 14 can include at least one second cradle mount opening 38 proximate to the first end 30 and arranged to receive a bolt or other connector therethrough for mounting the bracket to the vehicle cradle (not shown) which may include a corresponding opening for receiving the bolt or other connector.

The second extruded section 14 can include at least one second connection element 40, and there may be one second connection element 40 provided for each of the first connection elements 24. In at least some implementations, each second connection element 40 defines part of the second end 32 of the second body 28 and may include a convex, concave, and/or irregular shape. In some implementations and as illustrated in FIGS. 1 and 2, the second extruded section 14 includes multiple second connection elements 40 symmetrically aligned relative to the longitudinal axis A each including a generally concave void (e.g. slot or groove or hole) disposed proximate to or at the second end 32.

When the first extruded section 12 and the second extruded section 14 are press-fitted together and form the unitary extruded bracket 10, the first recess 22 and the second recess 34 form a circular opening 36 having an axis C, which can be configured to support a prop shaft coupled to the rear differential module. The first recess 22, the second recess 34, and the circular opening 36 can be configured to be installed over a shaft or post that extends coaxially with an axis of the circular opening 36 (perpendicular to longitudinal axis A). Further, openings 41 may be provided in the bracket to facilitate coupling the bracket to the differential module by multiple screws or bolts received through the openings 41.

In at least some implementations, the first extruded section 12 and the second extruded section 14 can be assembled/coupled together in a direction perpendicular to the longitudinal axis A and parallel with the axis C of the circular opening 36, which is perpendicular to the page in FIG. 1. When the sections 12 and 14 are coupled together the first connection elements 24 and the second connection elements 40 are moved axially together (relative to axis C) and engaged by an interlock and/or interference fit between the first connection elements 24 (e.g. projections) and the second connection elements 40 (e.g. voids). When the connection elements 24, 40 are mated together, they overlap in both a direction aligned with longitudinal axis A (the first connection elements 24 extend into and are received in the second connection elements 40) and in a direction aligned with axis B (perpendicular to both the longitudinal axis A and the axis C of the circular opening 36).

With respect to the overlap in the direction or dimension aligned with or otherwise in the direction of axis B, the first connection elements include an undercut or a thinner area that defines a smaller portion 42 with a smaller dimension aligned with axis B that is closer to the first end than a larger portion 44 outboard of the smaller portion 42 (where smaller and larger refer only to the dimension aligned with axis B). The second connection element 40 may likewise have a smaller portion 46, which is an area of the void having a smaller dimension aligned with or otherwise in the direction of the axis B, and a larger portion 48, which is an area of the void having a larger dimension aligned with or otherwise in the direction of the axis B. As shown in FIG. 2, the first and second connection elements 24, 40 may overlap on opposite sides of these elements, and may be uniformly overlapped on both sides or they may overlap on only one side, or they may overlap to a different extent on the opposite sides, as desired. Thus, the first connection element 24 and second connection element 40 can be configured to form an interlocking fit or coupling by way of an overlap 25 (FIG. 2) so that movement of the first extruded section 12 relative to the second extruded section 14 in a direction along the longitudinal axis A (perpendicular to the assembly direction) is inhibited or prevented by interference (e.g., engagement) of the first and second extruded sections 12, 14 in the area(s) of the overlap 25.

With respect to the overlap in the direction or dimension aligned with or otherwise in the direction of the axis A, the first extruded section 12 may have an end surface 50 adjacent to the first connection elements 24. The end surface 50 may be generally planar and oriented in the direction of the axes B and C, and perpendicular to the axis A, or otherwise shaped as desired. The first connection elements 24 have a free end 52 that is located farther away from the first end 18 of the first extruded section 12 than the end surface 50. Similarly, the second extruded section 14 may have an end surface 54 adjacent to the second connection elements 40. The end surface 54 may be generally planar and adapted to overlap and engage the end surface 50 of the first extruded section 12. And the second connection elements 40 may have a bottom 56 or inward most surface formed closer to the first end 30 of the second extruded section 14 than the end surface 54. The extent to which the first connection elements 24 extend into the second connection elements 40 define the extent of the overlap in the direction or dimension aligned with the axis A.

Finally, the thickness of the first section 12 and second section 14, in the direction or dimension aligned with the axis C, may be the same or different as desired. The thickness of the first and second connection elements 24, 40 may be the same as the thickness of the remainder of the first and second extruded sections 12, 14 or different. When coupled together, the first and second connection elements 24, 40 also overlap in the direction or dimension aligned with the axis C, as do the end surfaces 50, 54 which may be tightly pulled/compressed together to improve the structural integrity of the bracket.

The first extruded section 12 and the second extruded section 14 are press-fitted together, which provides a load-bearing interference fit between the sections 12, 14, where the external dimension of one connection element (e.g., first connection element 24) slightly exceeds the internal dimension of a corresponding second connection element (e.g., second connection element 40) into which it fits. For example, a radial or outer edge of a portion of the at least one first connection element 24, when in a projection (i.e. tab) configuration, can be slightly larger than a radial or inner edge of a portion of the void defining the corresponding second connection element 40, providing a tight, interference fit when the first connection element is received into the second connection element 40.

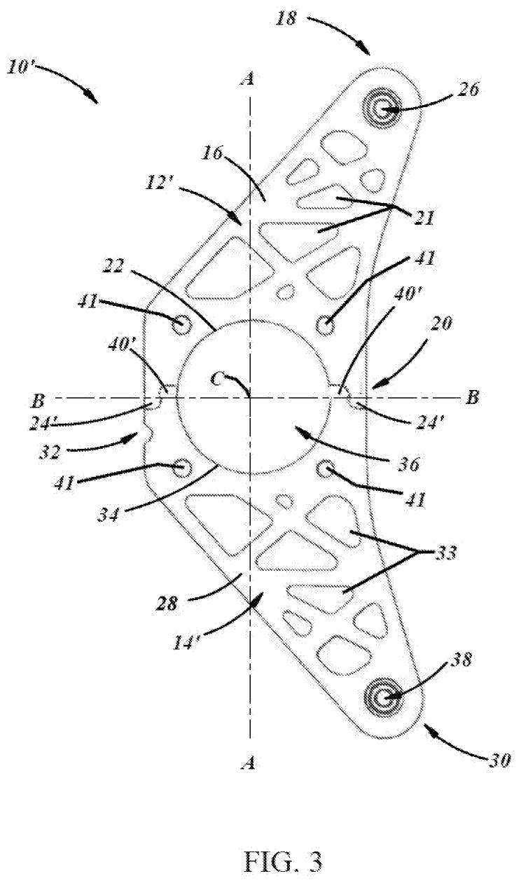

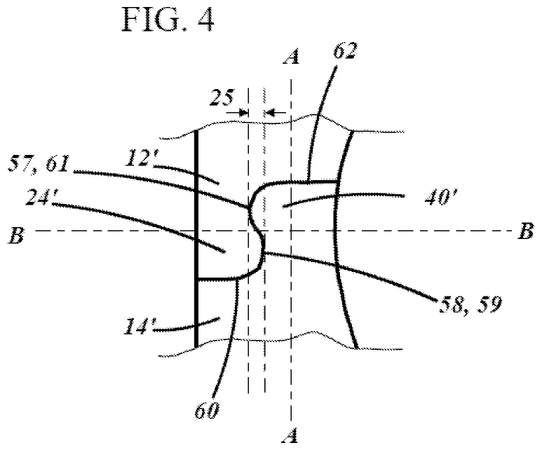

When the connection elements are in an undulated configuration, such as will be described next with reference to FIGS. 3 and 4, an inner radius of respective first connection element(s) 24′ and second connection element(s) 40′ can be slightly smaller than an outer radius of the respective corresponding first connection element(s) 24′ and second connection element(s) 40′. Because the external dimension and internal dimension of each connection do not exactly match, friction between each connection element is created when press-fitted together producing the interference fit and load-bearing strength, which opposes separation of the first extruded section 12 and the second extruded section 14 along the axis C of the circular opening 36. Disassembly of the first extruded section 12 and the second extruded section 14, both along longitudinal axis A and along the axis of the circular opening 36, can be prevented by the overlapped and interlocking connection and the interference fit between the first connection elements 24 and the second connection elements 40.

Additionally, press-fitting the first extruded section 12 and the second extruded section 14 may be performed at room temperature, although heating and/or cooling may be used to facilitate assembling the sections 12, 14 together, as desired.

Instead of the projection and void configuration shown in FIGS. 1 and 2, a bracket 10′ as shown in FIGS. 3 and 4 may include first and second connection elements 24′ and 40′ that are undulating (e.g. serpentine) and which, when mated together, provide a load bearing interference fit that resists separation of bracket sections 12′ and 14′ along the longitudinal axis A. The bracket 10′ may be similar or the same as the bracket 10 with the exception of the connection elements 24′ and 40′. Therefore, the description of the bracket 10′ will be limited to the differences between this bracket and the bracket 10 described above.

The connection elements 24′ of the first section 12′ may include curved portions that may define concave and convex portions 57, 58, respectively, when viewed in the direction of the axis B. The convex portion 58 may be farther from the first end 18 than is the concave portion 57. The connection elements 40′ of the second section 14′ may be complementarily shaped to the connection elements 24′ with oppositely arranged concave and convex portions 59, 61, respectively, adapted to be mated with the connection elements 24′ with an interference fit. The convex portion 61 may be farther from the first end 30 than is the concave portion 59. The concave portions 57, 59 may be considered voids, and the convex portions 58, 61 may be considered projections, where the projections of each connection element are received in/adjacent to a void of the connection element in the other extruded section. The convex portions (e.g. projections) may be slightly larger than the concave portions (voids), or the portions may have different curvatures/shapes such that they fit together with a tight interference fit and the bracket 10′ remains as a single, unitary piece under the forces exerted on the bracket in use.

Further, to prevent separation of the sections 12′ and 14′ in the longitudinal direction, the connection elements 24′ and 40′ may include an overlap 25 in a direction perpendicular to the longitudinal axis A (e.g. in the direction/dimension of axis B) with portions of each connection element 24′ and 40′ located closer to the axis C than other portions. In more detail, a portion of the first connection element 24′ that is farther from the first end 18 of the first extruded section 12′ is closer to the axis C than is a portion of the first connection element 24′ that is closer to the first end 18. And a portion of the second connection element 40′ that is farther from the first end 30 of the second extruded section 14′ is closer to the axis C than is a portion of the second connection element 40′ that is closer to the first end 32.

Also like the connection elements 24 and 40, the connection elements 24′ and 40′ are overlapped in a second dimension to prevent movement in the direction of the axis B. In the implementation shown, when the bracket sections 12′, 14′ are assembled together, a free or distal end 60 of at least one first connection element 24′ is closer to the first end 30 of the second extruded section 14′ than is a free or distal end 62 of at least one second connection element 40′.

Further areas of applicability of the present disclosure will become apparent from the detailed description, claims and drawings provided herein. It should be understood that the detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the inventions set forth herein.

For example, while the first connection elements 24 of the first section 12 were described as outwardly projection tabs, the first section 12 could include a connection element that is defined by a void, like a slot or groove as described with reference to the second connection elements 40 of the second section 14. The second section 14 could likewise include one or more outwardly extending connection element(s). That is, the bracket sections 12, 14 could include male and female connection elements in any desired configuration to achieve the press-fit and overlapped connection described herein. Other variations likewise may be used and are intended to be within the scope of the inventions set forth herein.

What is claimed is:

1. A bracket for mounting a drivetrain component to a vehicle, comprising:
a first extruded section having a first connection element; and
a second extruded section having a second connection element, where the first connection element is mated with the second connection element;
wherein the first extruded section and the second extruded section are press-fitted together with a load-bearing interference fit between the first connection element and the second connection element.

2. The bracket of claim 1 wherein the first connection element includes a projection that protrudes outwardly from the first extruded section and the second connection element includes a void arranged to receive the projection with an interference fit provided between the projection and the void.

3. The bracket of claim 1 wherein the first connection element and the second connection element are overlapped in a direction perpendicular to direction in which the first extruded section and second extruded section are press-fitted together.

4. The bracket of claim 1 wherein the first connection element and the second connection element are overlapped in two directions that are perpendicular to each other and are also perpendicular to the direction in which the first extruded section and second extruded section are press-fitted together.

5. The bracket of claim 2 wherein the first extruded section includes a first end and a second end, the first connection element is located at the second end of the first extruded section and has a larger portion and a smaller portion, and the smaller portion is closer to the first end than the larger portion.

6. The bracket of claim 5 wherein the second connection element is complementarily shaped to the first connection element.

7. The bracket of claim 5 wherein the first end is spaced from the second end along a longitudinal axis and the larger portion is larger than the smaller portion in a dimension perpendicular to the longitudinal axis.

8. The bracket of claim 5 wherein the first connection element has a distal end farthest from the first end, and wherein the second extruded section has a first end and a second end, the second connection element being located at the second end, and the distal end of the first connection element is closer to the first end of the second extruded section than is a portion of the second extruded section.

9. The bracket of claim 1 wherein the first connection element includes a concave portion and a convex portion and the second connection element includes a concave portion and a convex portion.

10. The bracket of claim 9 wherein the concave portion and convex portion of both the first connection element and the second connection element are oriented perpendicular to a direction in which the first extruded section and second extruded section are press-fitted together

11. The bracket of claim 9 wherein the convex portion of the first connection element is larger than, or has a different curvature or shape than, the concave portion of the second connection element.

12. An extruded bracket for mounting a drivetrain component to a vehicle structural component, comprising:
a first extruded section having a first connection element and a first recess; and
a second extruded section coupled to the first extruded section in a first direction, the second extruded section having a second connection element and a second recess, where the first connection element is coupled with and overlaps the second connection element parallel to a longitudinal axis of the first extruded section and second extruded section,
wherein the first recess and the second recess define a circular opening that is configured to be installed around a shaft, the circular opening having an axis that is perpendicular to the longitudinal axis; and
wherein the first extruded section and the second extruded section are press-fitted together with a load-bearing interference fit between the first connection element and the second connection element.

13. The bracket of claim 12 wherein the first connection element includes a projection that protrudes outwardly from the first extruded section and the second connection element includes a void arranged to receive the projection with an interference fit provided between the projection and the void.

14. The bracket of claim 12 wherein the first connection element includes a concave portion and a convex portion and the second connection element includes a concave portion and a convex portion.

15. The bracket of claim 12 wherein the first connection element and second connection element are overlapped in a direction perpendicular to both the longitudinal axis and the axis of the circular opening.
